(19) United States
(12) Patent Application Publication
(10) Pub. No.: US 2026/0196388 A1
(43) Pub. Date: Jul. 9, 2026

(54) SUPERCONDUCTING INTEGRATED CABLES AND PREPARATION METHODS THEREOF

(71) Applicant: MAIKUN (SUZHOU) ENGINEERING TECHNOLOGY CO., LTD, Suzhou (CN)

(72) Inventors: Xuesong LI, Suzhou (CN); Zhi ZHAO, Suzhou (CN); Xingxing ZHOU, Suzhou (CN); Yanyan ZOU, Suzhou (CN); Liyang YE, Suzhou (CN)

(73) Assignee: MAIKUN (SUZHOU) ENGINEERING TECHNOLOGY CO., LTD, Suzhou (CN)

(21) Appl. No.: 19/555,944

(22) Filed: Mar. 4, 2026

Related U.S. Application Data
(63) Continuation of application No. PCT/CN2025/090109, filed on Apr. 21, 2025.

(30) Foreign Application Priority Data
Apr. 26, 2024 (CN) 202410511158.9

(51) Int. Cl. H01B 13/02; H01B 12/08; H01B 13/00

(52) U.S. Cl. CPC H01B 13/0292; H01B 12/08; H01B 13/0016

(57) ABSTRACT

A method for preparing a superconducting integrated cable is provided, including: helically twisting a plurality of superconducting strands around a core wire to obtain a twisted cable; performing a heat treatment on the twisted cable to obtain an initial superconducting cable; performing a first eddy current test on the initial superconducting cable; and placing the initial superconducting cable after the first eddy current test in a groove on a side surface of a base material, and fixing the initial superconducting cable after the first eddy current test in the groove through a welding process to obtain the superconducting integrated cable. The method can not only improve a quality of the superconducting integrated cable, but also improve a production efficiency, while reducing a production cost of the superconducting integrated cable, thereby ensuring a quality and a supply of a superconducting magnet.

### CROSS-REFERENCE TO RELATED APPLICATIONS

This application is a Continuation of International Application No. PCT/CN2025/090109, filed on April 21, 2025, which claims priority to Chinese Patent Application No. 202410511158.9, filed on April 26, 2024, the entire contents of each of which are hereby incorporated by reference.

### TECHNICAL FIELD

The present disclosure generally relates to the field of superconducting technology, and in particular, to a superconducting integrated cable and a preparation method thereof.

### BACKGROUND

A superconductor, also known as a superconducting material, refers to a conductor that exhibits zero electrical resistance at a specific temperature. Beyond zero resistance, another crucial characteristic of the superconductor is perfect diamagnetism. These properties, namely zero electrical resistance and perfect diamagnetism, enable the superconductor to find broad applications across various fields, including power, transportation, medical treatment, science and technology, or the like. In the future, with continuous advancement of the science and technology, application prospects of the superconductor are expected to become even more expansive. In particular, the superconductor is a most important material for high-field superconducting magnet applications, and has been widely used in numerous fields such as high-energy particle accelerators, nuclear magnetic resonance (NMR) spectrometers, and the international thermonuclear experimental reactor (ITER).

In relevant arts, it is necessary to fabricate the superconductor into a superconducting integrated cable, which is then wound onto a superconducting magnet. Among these steps, the process of fabricating the superconductor into the superconducting integrated cable is most critical. With increasing demand for superconducting magnets, the current production capacity and yield of superconducting integrated cables are relatively low, severely impacting the supply and quality of the superconducting magnets.

Therefore, it is urgent to design a superconducting integrated cable and a preparation method thereof to obtain a high-quality superconducting integrated cable.

### SUMMARY

An objective of the present disclosure is to provide a superconducting integrated cable and a preparation method thereof, which not only improve a quality of the superconducting integrated cable, but also increase the production efficiency of the superconducting integrated cable, while reducing the production cost of the superconducting integrated cable, thereby ensuring the quality and supply of superconducting magnets.

One or more embodiments of the present disclosure provide a method for preparing a superconducting integrated cable. The method includes: helically twisting a plurality of superconducting strands around a core wire to obtain a twisted cable; performing a heat treatment on the twisted cable to obtain an initial superconducting cable; performing a first eddy current test on the initial superconducting cable; and placing the initial superconducting cable after the first eddy current test in a groove on a side surface of a base material, and fixing the initial superconducting cable after the first eddy current test in the groove through a welding process to obtain the superconducting integrated cable.

One or more embodiments of the present disclosure provide a superconducting integrated cable, which is obtained by implementing the method for preparing the superconducting integrated cable according to the above embodiments.

According to the superconducting integrated cable and the preparation method thereof provided in the present disclosure, at least the following advantages are achieved:

By twisting the plurality of superconducting strands around the core wire and installing the resulting cable on the base material, not only a critical current of the superconducting integrated cable can be increased, but the mechanical strength and resistance to a stress impact of the superconducting integrated cable can also be improved. In addition, the stability of the superconducting integrated cable during energized operation is enhanced, and eddy current issues caused by current variations are alleviated. By performing the heat treatment on the twisted cable, characteristics of the superconducting strands can be improved, thereby improving performance of the superconducting integrated cable. After the heat treatment is performed on the twisted cable and before the initial superconducting cable is installed into the groove of the base material, the first eddy current test is performed, which allows timely detection of defects within the twisted cable, enables prompt repair of the defects and adjustment of manufacturing parameters, and avoids defective products entering subsequent processes, thereby preventing waste and rework. The method not only reduces the production cost of the superconducting integrated cable and improves the production efficiency, but also further improves the quality of the superconducting integrated cable, thereby ensuring the quality and the supply of the superconducting magnets.

### BRIEF DESCRIPTION OF THE DRAWINGS

FIG. 1 is a flowchart illustrating an exemplary method for preparing a superconducting integrated cable according to some embodiments of the present disclosure.

FIG. 2 is a schematic diagram illustrating a structure of a superconducting integrated cable according to some embodiments of the present disclosure.

FIG. 3 is a schematic diagram illustrating a cross-section of a superconducting integrated cable according to some embodiments of the present disclosure.

FIG. 4 is a schematic diagram illustrating a cross-section of another superconducting integrated cable according to some embodiments of the present disclosure.

Reference signs: 1, superconducting strand; 2, core wire; 3, base material; 31, groove; 4, solder layer.

### DETAILED DESCRIPTION

Example embodiments will now be described more fully with reference to the accompanying drawings. However, the example embodiments may be implemented in various forms and should not be construed as limited to the embodiments set forth herein. Rather, these embodiments are provided to make the present disclosure thorough and complete, and to fully convey the concept of the example embodiments to those skilled in the art. In the drawings, the same reference numerals denote the same or similar structures, and thus repeated descriptions thereof will be omitted.

The words describing positions and directions in the present disclosure are all described by way of example with reference to the drawings, but the words may be changed as needed, and all changes made are included within the protection scope of the present disclosure.

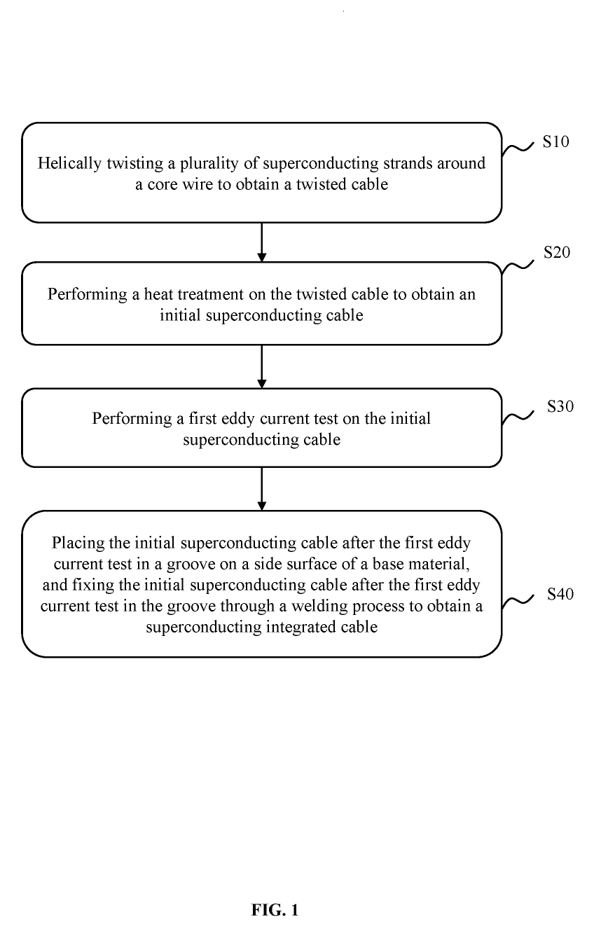

FIG. 1 is a flowchart illustrating an exemplary method for preparing a superconducting integrated cable according to some embodiments of the present disclosure.

With reference to FIG. 1, the present disclosure provides a method for preparing the superconducting integrated cable, including operations S10-S40.

In S10, a plurality of superconducting strands may be helically twisted around a core wire to obtain a twisted cable.

The superconducting strand may be a basic unit constituting the superconducting integrated cable. The superconducting strand may be composed of one or more superconducting materials.

The twisted cable may be a main body portion constituting the superconducting integrated cable.

In some embodiments, a count of the superconducting strands, a diameter of each of the superconducting strands, a diameter of the core wire, a twist pitch of the twisted cable, etc., may be set according to actual requirements. For example, the count of the plurality of superconducting strands is in a range of 3 to 6, e.g., 4 or 5. As another example, the count of the plurality of superconducting strands is in a range of 4 to 8, e.g., 6 or 7. As yet another example, the count of the superconducting strands is in a range of 6 to 10, e.g., 8 or 9.

In some embodiments, the diameter of each the plurality of superconducting strands is in a range of 0.3 mm to 1.5 mm, e.g., 0.9 mm or 1.0 mm. In some embodiments, the diameter of each the plurality of superconducting strands is in a range of 0.5 mm to 1.1 mm, e.g., 0.8 mm or 1.1 mm. In some embodiments, the diameter of each the plurality of superconducting strands is in a range of 0.7 mm to 1.0 mm, e.g., 0.7 mm or 0.8 mm.

In some embodiments, the diameter of the core wire is in a range of 0.1 mm to 0.8 mm, e.g., 0.3 mm or 0.2 mm. In some embodiments, the diameter of the core wire is in a range of 0.2 mm to 0.5 mm, e.g., 0.4 mm or 0.5 mm. In some embodiments, the diameter of the core wire is in a range of 0.5 mm to 0.8 mm, e.g., 0.6 mm or 0.8 mm.

In some embodiments, the twist pitch of the twisted cable is in a range of 5 mm to 35 mm, e.g., 15 mm or 10 mm. In some embodiments, the twist pitch of the twisted cable is in a range of 10 mm to 25 mm, e.g., 20 mm or 18 mm. In some embodiments, the twist pitch of the twisted cable is in a range of 20 mm to 35 mm, e.g., 25 mm or 30 mm.

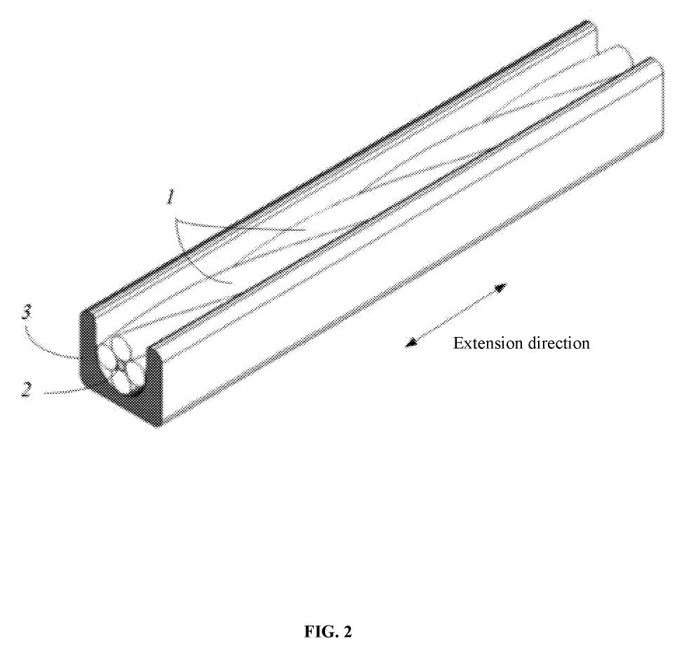

FIG. 2 is a schematic diagram illustrating a structure of a superconducting integrated cable according to some embodiments of the present disclosure.

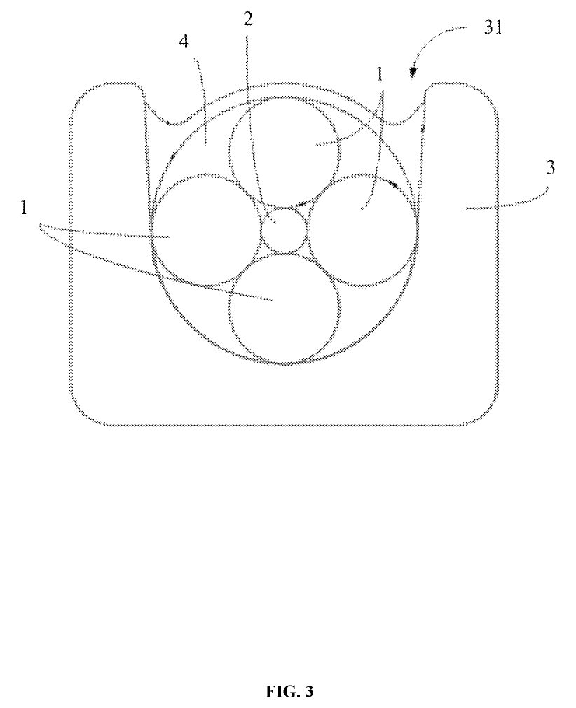

FIG. 3 is a schematic diagram illustrating a cross-section of a superconducting integrated cable according to some embodiments of the present disclosure.

In this embodiment, with reference to FIGS. 2 and 3, a count of superconducting strands 1 is four, and a count of core wire 2 is one. Merely by way of example, a diameter of each superconducting strand 1 is in a range of 0.5 mm to 1.1 mm, a diameter of the core wire 2 is in a range of 0.2 mm to 0.5 mm, and a twist pitch of a twisted cable is in a range of 10 mm to 25 mm. The plurality of superconducting strands 1 are helically twisted around the core wire 2 with the core wire 2 as a central axis to obtain the twisted cable.

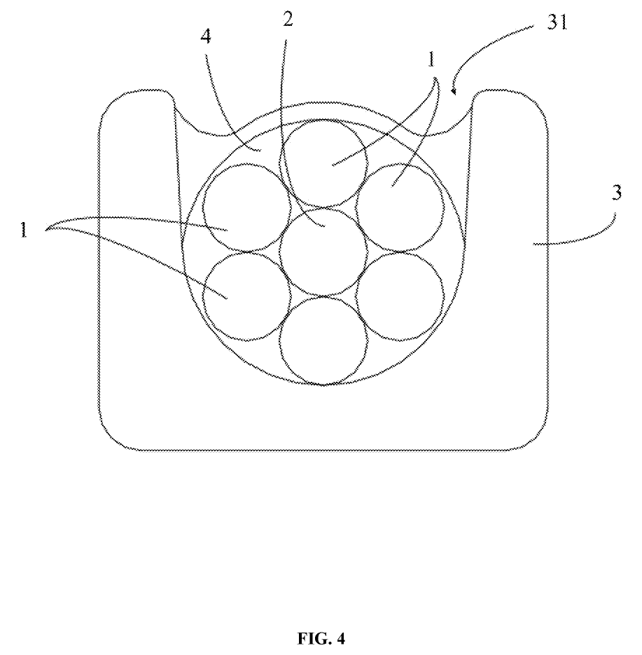

FIG. 4 is a schematic diagram illustrating a cross-section of another superconducting integrated cable according to some embodiments of the present disclosure.

In some embodiments, with reference to FIG. 4, the count of the superconducting strands 1 is six, the count of the core wire 2 is one, and the six superconducting strands 1 are helically twisted around the core wire 2 with the core wire 2 as the central axis.

In some embodiments, each superconducting strand of the plurality of superconducting strands includes a plurality of superconducting filaments (also referred to as superconducting fine filaments). A count of the superconducting filaments determines a critical current of the superconducting strand (i.e., a maximum current that the superconducting strand can carry), thereby determining a critical current of the superconducting integrated cable (i.e., a maximum current that the superconducting integrated cable can carry, such as 2800 A, 2700 A, etc.). The count of the plurality of superconducting filaments may be set according to actual requirements.

In some embodiments, the superconducting strands may be Nb₃Sn superconducting strands.

In some embodiments of the present disclosure, the Nb₃Sn superconducting strand enables the superconducting strand to achieve a high critical current density. In a superconducting state, the superconducting strand can carry a high current, thereby meeting the requirements of high-current applications. The Nb₃Sn superconducting strand also possesses a high critical temperature, allowing the superconducting strand to maintain the superconducting state at a relatively high temperature, which reduces power consumption and cost of refrigeration equipment. Furthermore, the Nb₃Sn superconducting strand also exhibits excellent corrosion resistance and maintains stable performance even in a harsh environment. Additionally, the Nb₃Sn superconducting strand also demonstrates superior magnetic field stability, avoiding issues such as hysteresis effects and magnetic field leakage, and is suitable for high-precision magnetic field measurement and control.

In some embodiments, a material of the core wire is one or more of copper or iron.

In some embodiments, the method further includes winding the twisted cable onto a component such as a conical drum to facilitate subsequent process operations. The twisted cable may also be twisted onto a component such as a steel wheel.

The present disclosure employs a plurality of superconducting strands. These superconducting strands are arranged closely and parallel to each other, which can rapidly increase the critical current of the superconducting integrated cable, thereby adapting it to a wider range of application scenarios. Furthermore, the method is simple, which reduces production difficulty and saves manufacturing costs. The material of the core wire is one or more of copper, iron, etc., serving to enhance the mechanical strength of the plurality of superconducting strands and improve the mechanical strength and stress impact resistance of the superconducting integrated cable. In addition, the helical winding of the superconducting strands around the core wire can significantly reduce eddy currents during current variations, thereby enhancing the operational stability of the final superconducting integrated cable during energization.

In S20, heat treatment may be performed on the twisted cable to obtain an initial superconducting cable.

The initial superconducting cable refers to a superconducting integrated cable at an initial preparation stage.

In some embodiments, the heat treatment may include tin-pot tinning, sealed‑jacket heat treatment, or the like. The sealed‑jacket heat treatment includes loading the twisted cable into a sealed jacket made of a specific material (e.g., stainless steel), evacuating and sealing the sealed jacket, and then placing the sealed jacket into a heat treatment device for the heat treatment. The present disclosure does not limit the process of the heat treatment.

In some embodiments, a temperature corresponding to the heat treatment, holding durations at different temperatures, or the like, may be set based on actual requirements.

In some embodiments, the heat treatment includes placing the twisted cable into the heat treatment device, evacuating the heat treatment device, and then performing the heat treatment to obtain the initial superconducting cable. A vacuum degree inside the heat treatment device is less than a preset vacuum degree (e.g., 5×10⁻³ Pa). Performing the heat treatment on the twisted cable in a vacuum environment or a sub-vacuum environment can effectively prevent the twisted cable from undergoing an oxidation reaction with oxygen in the air at high temperatures, thereby reducing an oxide layer on a material surface and facilitating maintenance of purity and superconducting performance of the Nb₃Sn superconducting strand. This treatment process can also reduce contamination of the twisted cable by impurities in a gas phase, and be beneficial for improving purity and superconducting performance of the material. Simultaneously, the treatment process can reduce a gas phase diffusion resistance, which is beneficial for collision and diffusion between reactant molecules, accelerates a reaction rate, and promotes the formation of a superconducting phase in the twisted cable. The treatment process can also better control a gas pressure, preventing gas interference during the heat treatment and ensuring both the stability and repeatability of conditions of the heat treatment.

In some other embodiments, a protective gas may also be introduced into the heat treatment device. The protective gas may be an inert gas or a reducing gas (e.g., hydrogen). The inert gas includes nitrogen, argon, or the like. The protective gas can quickly expel air from the heat treatment device, prevent oxidation and reduce impurities while maintaining stable and controllable gas pressure, thereby improving quality and superconducting performance of the final Nb₃Sn superconducting strand.

In some embodiments, the heat treatment device may include a box furnace, a bell furnace, a tube furnace, or the like.

In some embodiments, the heat treatment may employ a step temperature profile. The step temperature profile may include a heating stage and a holding stage.

In some embodiments, the step temperature profile may include a plurality of heating stages and a plurality of holding stages.

Employing the step temperature profile can control the reaction rate of the superconducting strand at different temperatures, thereby optimizing the formation of the superconducting phase in the superconducting strand and improving the superconducting performance. The process of forming the superconducting phase in the superconducting strand involves changes in a lattice structure and generates stress. Furthermore, employing the step temperature profile allows the superconducting phase of the superconducting strand to form stepwise at the different temperatures, reducing generation of stress, thereby avoiding negative effects of the stress on the superconducting strand. In addition, employing the step temperature profile also allows the superconducting strand to react uniformly at the different temperatures, thereby improving uniformity and consistency of the superconducting strand and ensuring that the final superconducting strand has good superconducting performance. During the heat treatment, overheating or overcooling may lead to a reduction in the superconducting performance of the superconducting strands, employing the step temperature profile can prevent the superconducting strand from being affected by the overheating or overcooling, thereby ensuring the superconducting performance of the final superconducting strand.

In some embodiments, the heating stage includes a first heating stage, a second heating stage, and a third heating stage. The holding stage includes a first holding stage, a second holding stage, and a third holding stage. The heating stage and the holding stage are alternately distributed. That is, the step temperature profile sequentially includes the first heating stage, the first holding stage, the second heating stage, the second holding stage, the third heating stage, and the third holding stage.

In some embodiments, a temperature of the first holding stage may be in a range of 200 °C to 220 °C, e.g., 200 °C or 220 °C, and a duration of the first holding stage may be in a range of 70 to 80 hours, e.g., 70 hours or 80 hours; a temperature of the second holding stage may be in a range of 390 °C to 410 °C, e.g., 390 °C or 410 °C, and a duration of the second holding stage may be in a range of 45 to 55 hours, e.g., 45 hours or 55 hours; and a temperature of the third holding stage may be in a range of 645 °C to 685 °C, e.g., 645 °C or 685 °C, and a duration of the third holding stage may be in a range of 45 to 55 hours, e.g., 45 hours or 55 hours.

In some embodiments, a duration of the first heating stage is in a range of 8 to 14 hours, heating from the room temperature to between 200 °C and 220 °C; a duration of the second heating stage is in a range of 30 to 40 hours, heating to between 390 °C and 410 °C; and a duration of the third heating stage is in a range of 45 to 55 hours, heating to between 645 °C and 685 °C.

In some embodiments, the temperature of the first holding stage includes a range of 180 °C to 240 °C, e.g., 190 °C or 210 °C; the duration of the first holding stage may be in a range of 60 to 100 hours, e.g., 60 hours or 90 hours; the temperature of the second holding stage may be in a range of 370 °C to 430 °C, e.g., 380 °C or 420 °C; the duration of the second holding stage may be in a range of 35 to 65 hours, e.g., 35 hours or 65 hours; the temperature of the third holding stage may be in a range of 630 °C to 700 °C, e.g., 630 °C or 700 °C; and the duration of the third holding stage may be in a range of 35 to 65 hours, e.g., 35 hours or 65 hours.

In some embodiments, the duration of the first heating stage is in a range of 10 to 12 hours, heating from the room temperature to between 180 °C and 240 °C; the duration of the second heating stage is in a range of 32 to 38 hours, heating to between 370 °C and 430 °C; and the duration of the third heating stage is in a range of 48 to 52 hours, heating to between 630 °C and 700 °C.

In some embodiments, the temperature of the first holding stage may further be in a range of 205 °C to 225 °C, e.g., 225 °C or 205 °C; the duration of the first holding stage may further be in a range of 80 to 100 hours, e.g., 90 hours or 100 hours; the temperature of the second holding stage may further be in a range of 400 °C to 420 °C, e.g., 400 °C or 415 °C; the duration of the second holding stage may further be in a range of 50 to 60 hours, e.g., 50 hours or 60 hours; the temperature of the third holding stage may further be in a range of 650 °C to 710 °C, e.g., 675 °C or 695 °C; and the duration of the third holding stage may further be in a range of 50 to 60 hours, e.g., 50 hours or 60 hours.

In some embodiments, the duration of the first heating stage is in a range of 7 to 15 hours, heating from the room temperature to between 205 °C and 225 °C; the duration of the second heating stage is in a range of 28 to 42 hours, heating to between 400 °C and 420 °C; and the duration of the third heating stage is in a range of 43 to 57 hours, heating to between 675 °C and 695 °C.

In some embodiments, ranges of the temperature and the duration of each heating stage and each holding stage may be set based on actual requirements. The count of the heating stages and the holding stages may be set based on actual requirements.

In some embodiments, the step temperature profile may further include a cooling stage. A duration of the cooling stage is in a range of 20 to 30 hours, cooling from the third holding stage to the room temperature, to prevent a too rapid temperature drop from causing a reduction in the superconducting performance of the superconducting strands.

In some embodiments, the duration of the cooling stage may also be a range of 15 to 45 hours, 20 to 40 hours, or the like.

In S30, a first eddy current test may be performed on the initial superconducting cable.

The eddy current test may utilize an electromagnetic induction principle to detect defects on or near a surface of the superconducting material and to detect material characteristics of the superconducting material. In some embodiments, the eddy current test may be implemented by an eddy current tester or the like.

Defects may be generated during the preparation of the superconducting integrated cable, and most of the defects may occur during the heat treatment of the twisted cable.

In some embodiments, performing the first eddy current test on the initial superconducting cable may detect defects that may be generated during the preparation of the initial superconducting cable. The first eddy current test can timely detect defects in the twisted cable, thereby promptly reminding technicians to repair the defects and adjust manufacturing parameters, which improves the product yield and product quality, and avoids waste and rework caused by defective products flowing into subsequent processes. By performing the first eddy current test on the initial superconducting cable, not only the production cost of the superconducting integrated cable can be reduced and the production efficiency of the superconducting integrated cable can be improved, but also the quality of the superconducting integrated cable can be improved, thereby ensuring the quality and supply of the superconducting magnet.

In S40, the initial superconducting cable after the first eddy current test may be placed in a groove on a side surface of a base material, and the initial superconducting cable after the first eddy current test may be fixed in the groove through a welding process to obtain the superconducting integrated cable.

The base material may be a carrier of the initial superconducting cable.

In some embodiments, a material of the base material includes one or more of copper, iron, or the like. The base material may be strip-shaped. The material of the base material may also be other metal materials with a high strength, to improve the mechanical strength and the resistance to the stress impact of the superconducting integrated cable. The base material also functions to stably protect the superconducting strand and the core wire.

In some embodiments, the material of the base material may be copper, thereby increasing a copper-to-superconductor ratio and further improving mechanical stability and electrical stability of the superconducting integrated cable. The copper-to-superconductor ratio may be a ratio of a cross-sectional area of copper to a cross-sectional area of the superconducting material (e.g., the Nb₃Sn superconducting strand).

In some embodiments, referring to FIGS. 2 and 3, a base material 3 is overall strip-shaped, a groove 31 is disposed on a side surface of the base material 3, both the groove 31 and the base material 3 extend along a same direction, and the groove 31 may be U-shaped, V-shaped, or other shapes capable of accommodating the initial superconducting cable. The initial superconducting cable is installed in the groove 31 of the base material 3, and after the tin-pot tinning at a soldering temperature of 230 °C to 450 °C, a soldering material forms a solder layer 4. The soldering material is tightly connected to an inner surface of the groove 31, an outer surface of the superconducting strand, and an outer surface of the core wire, to obtain the superconducting integrated cable. The soldering material may fixedly connect the superconducting strand, the core wire, and the base material.

The present disclosure first performs the heat treatment on the twisted cable, and then performs the welding process on the initial superconducting cable and the base material, rather than first performing the welding process on the twisted cable and the base material and then performing the heat treatment.

The present disclosure first performs the heat treatment on the twisted cable, and then performs the welding process on the initial superconducting cable and the base material. On one hand, this operation can detect defects caused by the heat treatment in advance, avoiding performing the welding process on defective products and the base material. On the other hand, this operation can also promptly remind technicians to repair the defects and adjust the manufacturing parameters, thereby improving an overall yield and efficiency. On the other hand, because the temperature of the heat treatment is far greater than the temperature of the welding process, if the welding process is first performed on the twisted cable and the base material and then the heat treatment is performed, this may cause the soldering material to soften or even melt. The soldering material cannot fixedly connect the superconducting strand, the core wire, and the base material, i.e., the superconducting strand and the core wire may separate from the base material, thereby reducing the mechanical stability of the superconducting integrated cable. The melted soldering material not only causes undesirable phenomena such as burrs on the surface of the solder layer, but also spreads to adjacent strands and causes adhesion. After forced separation, local dimensions of the strands are poor, and the strands may even break, thereby reducing the product yield and quality.

Furthermore, if the welding process is first performed on the twisted cable and the base material and then the heat treatment is performed, because the superconducting strands are attached with the solder layer, during the heat treatment, the solder layer may react with the superconducting strands, i.e., the solder layer may diffuse into the superconducting strands, thereby reducing the superconducting performance of the superconducting strands. In a conventional process, a protective layer needs to be first formed on a surface of the twisted cable, i.e., the protective layer is formed on a surface of the superconducting strands, followed by the welding process, then a tin removal treatment, and finally the heat treatment. The tin removal treatment is to remove excess solder on the surface of the superconducting strands, preventing the solder from spreading to adjacent strands and causing adhesion. At the same time, excessive tin removal must also be prevented, which may lead to insufficient bonding force between the twisted cable and the base material and cause separation, thereby reducing the product yield and quality. Therefore, the conventional process is complicated, prolongs the production cycle, reduces production efficiency and capacity, imposes high precision requirements on production parameters, and reduces product yield.

In summary, the present disclosure first performs the heat treatment on the twisted cable, and then performs the welding process on the initial superconducting cable and the base material, which not only ensures the superconducting performance of the superconducting strands, thereby improving the product yield and quality, but also simplifies the production process, improves the production efficiency, ensures the supply of superconducting magnets, and reduces production costs.

In some embodiments, the method further includes performing a second eddy current test on the superconducting integrated cable. The second eddy current test may be performed before the superconducting integrated cable is twisted into the superconducting magnet. The second eddy current test may detect defects generated during the preparation of the superconducting integrated cable, ensuring the quality of the superconducting integrated cable and avoiding inaccurate defect localization caused by performing defect detection after the superconducting integrated cable is twisted into the superconducting magnet. Performing the second eddy current test on the superconducting integrated cable not only improves efficiency and accuracy of defect detection and enhances the quality of the superconducting magnet, but also avoids rework of the superconducting magnet due to an existence of defects, thereby improving the production efficiency and reducing the production costs.

The present disclosure also provides a superconducting integrated cable, obtained by the method for preparing the superconducting integrated cable according to any one of the above embodiments.

Embodiments and comparative examples of the present disclosure will be described in detail below. However, those skilled in the art should understand that the following embodiments are only for illustrating the present disclosure and should not be considered as limiting the scope of the present disclosure.

The following embodiment is a preparation process of a superconducting integrated cable according to the method provided in the present disclosure. The preparation process of the embodiment includes operations S11-S14.

In S11, four Nb₃Sn superconducting strands, each with a diameter of 0.778 mm, and one copper core wire with a diameter of 0.32 mm were provided, and the four superconducting strands were helically twisted around the core wire to obtain a twisted cable, with a twist pitch of the twisted cable being 18 mm.

In S12, a heat treatment was performed on the twisted cable obtained in S11 in an environment with a vacuum degree of less than 5×10⁻³ Pa, the heat treatment specifically including, in sequence: a first heating stage lasting 10 hours, heating the temperature within a heat treatment device from the room temperature to 210 °C; a first holding stage maintaining 210 °C for 78 hours; a second heating stage lasting 36 hours, heating to 400 °C; a second holding stage maintaining 400 °C for 48 hours; a third heating stage lasting 53 hours, heating to 665 °C; a third holding stage maintaining 665 °C for 50 hours; and a cooling stage lasting 25 hours, cooling the temperature within the heat treatment device from 665 °C down to the room temperature, thereby obtaining a first superconducting cable.

In S13, a first eddy current test was performed on the first superconducting cable obtained in S12.

In S14: a base material was provided; a side surface of the base material was provided with a groove, a width of the base material was 3.18 mm, a height of the base material was 2.54 mm, a width of the groove was 2.11 mm, and a height of the groove was 2.08 mm; the first superconducting cable after the first eddy current test obtained in S13 was installed into the groove of the base material, and tin-pot tinning was performed at a soldering temperature of 340 °C, such that the first superconducting cable was fixed in the groove, thereby obtaining the superconducting integrated cable.

The following comparative embodiment is a preparation process of the superconducting integrated cable according to a conventional technology for preparing the superconducting integrated cable. The preparation process of the comparative embodiment includes operations S21-S24.

In S21, four Nb₃Sn superconducting strands, each with a diameter of 0.778 mm, and one copper core wire with a diameter of 0.32 mm were provided, and the four superconducting strands were helically twisted around the core wire to obtain a twisted cable, with a twist pitch of the twisted cable being 18 mm.

In S22, a base material was provided; a side surface of the base material was provided with a groove; a width of the base material was 3.18 mm, a height of the base material was 2.54 mm, a width of the groove was 2.11 mm, and a height of the groove was 2.08 mm; the twisted cable obtained in S21 was installed into the groove of the base material, and tin-pot tinning was performed at a soldering temperature of 340 °C, such that the twisted cable was fixed in the groove, to obtain a second superconducting cable.

In S23, a first eddy current test was performed on the second superconducting cable obtained in S22.

In S24, a heat treatment was performed on the second superconducting cable after the first eddy current test obtained in S23 in an environment with a vacuum degree of less than 5×10⁻³ Pa; the heat treatment specifically including, in sequence: a first heating stage lasting 10 hours, heating the temperature within a heat treatment device from the room temperature to 210 °C; a first holding stage maintaining 210 °C for 78 hours; a second heating stage lasting 36 hours, heating to 400 °C; a second holding stage maintaining 400 °C for 48 hours; a third heating stage lasting 53 hours, heating to 665 °C; a third holding stage maintaining 665 °C for 50 hours; and a cooling stage lasting 25 hours, cooling the temperature within the heat treatment device from 665 °C down to the room temperature, thereby obtaining a superconducting integrated cable.

The superconducting integrated cable obtained in the embodiment was tested under a conditions of 273K/20K, yielding a residual resistivity ratio (RRR) value of 150, and the superconducting integrated cable obtained in the comparative embodiment was tested under the conditions of 273K/20K, yielding a RRR value of 125. The RRR value of the superconducting integrated cable of the embodiment is higher, indicating that first performing the heat treatment on the twisted cable and then performing the welding process on the initial superconducting cable (e.g., the first superconducting cable) and the base material avoids a reaction between the solder layer and the superconducting strands, i.e., avoids a diffusion of the solder layer into the superconducting strands, thereby increasing the RRR value of the superconducting integrated cable and further improving the superconducting performance of the superconducting integrated cable. The conditions of 273K/20K refer to testing a resistance value of the superconducting integrated cable at a temperature of 273K and testing a resistance value of the superconducting integrated cable at a temperature of 20K. A ratio of the resistance value measured at the temperature of 273K to the resistance value measured at the temperature of 20K is the RRR value.

Under conditions of 12T and 4.2K (a magnetic field intensity is 12T, and a temperature is 4.2K), a current was applied to the superconducting integrated cable obtained in the embodiment until the superconducting state of the superconducting integrated cable transitioned to a normal state, and the current at this moment is defined as the critical current. After testing, the critical current of the superconducting integrated cable can reach above 2800 A. The superconducting integrated cable obtained by the method of the present disclosure has a relatively high critical current, and performance of the superconducting integrated cable can be significantly improved. At the same time, the method can improve the product yield and quality of the superconducting integrated cable, and avoid the defective products flowing into the subsequent processes to cause the waste and rework. The method of the present disclosure not only reduces the production cost of the superconducting integrated cable and improves the production efficiency of the superconducting integrated cable, but also further improves the quality of the superconducting integrated cable, thereby ensuring the quality and the supply of the superconducting magnet.

In some embodiments, a method for preparing a superconducting integrated cable includes following operations.

In S10, a plurality of superconducting strands and a core wire may be provided, and the plurality of superconducting strands may be helically twisted around the core wire to obtain a twisted cable.

In S20, a heat treatment may be performed on the twisted cable obtained in S10 to obtain an initial superconducting cable.

In S30, a first eddy current test may be performed on the initial superconducting cable obtained in S20.

In S40, a base material may be provided; a side surface of the base material may be provided with a groove; the initial superconducting cable after the first eddy current test obtain in S30 may be installed into the groove of the base material, and a welding process may be performed to fix the initial superconducting cable after the first eddy current test in the groove, thereby obtaining the superconducting integrated cable.

In some embodiments, the method further includes S50. In S50, a second eddy current test may be performed on the superconducting integrated cable obtained in S40.

In some embodiments, the superconducting strands are Nb₃Sn superconducting strands, and each superconducting strand is composed of a plurality of superconducting fine filaments (also referred to as superconducting filaments).

In some embodiments, a count of the superconducting strands is four, a diameter of each superconducting strand is in a range of 0.5 mm to 1.1 mm, a diameter of the core wire is in a range of 0.2 mm to 0.5 mm, and a twist pitch of the twisted cable is in a range of 10 mm to 25 mm.

In some embodiments, S10 further includes: winding the twisted cable onto the conical drum.

In some embodiments, performing the heat treatment in S20 includes: performing the heat treatment on the twisted cable obtained in S10 in a vacuum environment or an inert gas atmosphere, where the heat treatment employs a step temperature profile including a heating stage and a holding stage.

In some embodiments, the heating stage includes a first heating stage, a second heating stage, and a third heating stage, and the holding stage includes a first holding stage, a second holding stage, and a third holding stage.

In some embodiments, a temperature of the first holding stage is in a range of 200 °C to 220 °C, and a duration of the first holding stage is in a range of 70 to 80 hours; a temperature of the second holding stage is in a range of 390 °C to 410 °C, and a duration of the second holding stage is in a range of 45 to 55 hours; and a temperature of the third holding stage is in a range of 645 °C to 685 °C, and a duration of the third holding stage is in a range of 45 to 55 hours.

In some embodiments, a material of the core wire is one or more of copper or iron.

In some embodiments, a material of the base material is one or more of copper or iron.

The present disclosure further provides a superconducting integrated cable, which is obtained by implementing the method for preparing a superconducting integrated cable described in the above embodiments.

What is claimed is:

1. A method for preparing a superconducting integrated cable, comprising:
helically twisting a plurality of superconducting strands around a core wire to obtain a twisted cable;
performing a heat treatment on the twisted cable to obtain an initial superconducting cable;
performing a first eddy current test on the initial superconducting cable; and
placing the initial superconducting cable after the first eddy current test in a groove on a side surface of a base material, and fixing the initial superconducting cable after the first eddy current test in the groove through a welding process to obtain the superconducting integrated cable.

2. The method of claim 1, further comprising:
performing a second eddy current test on the superconducting integrated cable.

3. The method of claim 1, wherein the plurality of superconducting strands are Nb₃Sn superconducting strands, and each superconducting strand of the plurality of superconducting strands includes a plurality of superconducting filaments.

4. The method of claim 1, wherein a count of the plurality of superconducting strands in a range of 3 to 6, a diameter of each of the plurality of superconducting strands in a range of 0.3 mm to 1.5 mm, a diameter of the core wire in a range of 0.1 mm to 0.8 mm, and a twist pitch of the twisted cable in a range of 5 mm to 35 mm.

5. The method of claim 1, further comprising:
winding the twisted cable onto a conical drum.

6. The method of claim 1, wherein performing the heat treatment includes:
performing the heat treatment on the twisted cable in a vacuum environment or an inert gas atmosphere, wherein the heat treatment employs a step temperature profile including a heating stage and a holding stage.

7. The method of claim 6, wherein the heating stage includes a first heating stage, a second heating stage, and a third heating stage, and the holding stage includes a first holding stage, a second holding stage, and a third holding stage;
a temperature of the first holding stage is in a range of 180° C to 240 °C, and a duration of the first holding stage is in a range of 60 to 100 hours; and/or
a temperature of the second holding stage is in a range of 370 °C to 430 °C, and a duration of the second holding stage is in a range of 35 to 65 hours; and/or
a temperature of the third holding stage is in a range of 630 °C to 700 °C, and a duration of the third holding stage is in a range of 35 to 70 hours.

8. The method of claim 1, wherein a material of the core wire is one or more of copper or iron.

9. The method of claim 1, wherein a material of the base material is one or more of copper or iron.

10. A superconducting integrated cable, wherein the superconducting integrated cable is obtained by the method of claim 1.

11. The method of claim 6, wherein the step temperature profile further includes a cooling stage, and a duration of the cooling stage is in a range of 20 to 30 hours.

12. The method of claim 6, wherein the vacuum environment is such that a vacuum degree inside a heat treatment device is less than a preset vacuum degree.

13. The method of claim 7, wherein a duration of the first heating stage is in a range of 8 to 14 hours, heating from a room temperature to between 200 °C and 220 °C; a duration of the second heating stage is in a range of 30 to 40 hours, heating to between 390 °C and 410 °C; and a duration of the third heating stage is in a range of 45 to 55 hours, heating to between 645 °C and 685 °C.

14. The method of claim 1, wherein the welding process includes tin-pot tinning, with a soldering temperature ranging from 230 °C to 450 °C.

15. The method of claim 2, wherein the second eddy current test is performed before the superconducting integrated cable is wound into a superconducting magnet.
